(19) United States
(12) Patent Application Publication
(10) Pub. No.: US 2024/0014716 A1
(43) Pub. Date: Jan. 11, 2024

(54) HORIZONTAL ASSEMBLY METHOD FOR PERMANENT MAGNET MOTOR

(71) Applicant: TECO Electric & Machinery Co., Ltd., TAIPEI CITY (TW)

(72) Inventors: Lian-Shin HUNG, TAIPEI CITY (TW); Ming-Te HO, TAIPEI CITY (TW); Cheng-Wei LO, TAIPEI CITY (TW)

(21) Appl. No.: 17/968,521

(22) Filed: Oct. 18, 2022

(30) Foreign Application Priority Data
Jul. 8, 2022 (TW) 111125641

(51) Int. Cl. H02K 15/00

(52) U.S. Cl. CPC H02K 15/00

(57) ABSTRACT

A horizontal assembly method for permanent magnet motor is mainly to firstly dispose the first bracket and the second bracket on the motor assembly platform, then fix the stator assembly on the sliding carrier so as to move with the sliding carrier to sleeve over the fixed thimble to engage the first bracket, then position the rotor assembly between the fixed thimble and the movable thimble so as to fix the rotor assembly by the protruding movable thimble, then control the sliding carrier to assemble the stator assembly and the first bracket to the rotor assembly so that the one end of the rotational shaft can be supported by the first bracket, and finally assemble the second bracket to the stator assembly so as to support another end of the rotational shaft. Thereupon, the permanent magnet motor can be produced.

This application claims the benefit of Taiwan Patent Application Serial No. 111125641, filed Jul. 8, 2022, the subject matter of which is incorporated herein by reference.

### BACKGROUND OF THE INVENTION

### (1) Field of the Invention

The invention relates to a method for assembling a permanent magnet motor, and more particularly to a horizontal assembly method for permanent magnet motor.

### (2) Description of the Prior Art

Generally speaking, in assembling a stator assembly with electromagnets and a rotor assembly with magnets to form a permanent magnet motor, an air gap spacer is applied between the rotor assembly and the stator assembly so as to prevent the assembling thereof from being affected by the magnetic effect in between.

As described, the air gap spacer is disposed between the rotor assembly and the stator assembly to avoid direct contact between the rotor assembly and the stator assembly. After the rotor assembly has been assembled to the stator assembly, then the air gap spacer can be removed. However, in order to remove the air gap spacer from the assembled permanent magnet motor, a corresponding support bracket shall be drilled in advance, and thus the cost for manufacturing the permanent magnet motor would be hiked. In addition, the assembling of a large-scale motor becomes much more difficult.

In addition, though the air gap spacer can be effectively removed through the drill holes at the support bracket, yet positions of the drill holes are not fixed due that the dimensions of the support bracket vary from one permanent magnet motor to another. Thus, the positions of the drill holes need to be adjusted to meet different sizes of the support bracket, and so accompanying inconvenience arises therefrom.

### SUMMARY OF THE INVENTION

In view that, in the art, the assembling of the permanent magnet motor shall introduce the air gap spacer to prevent the rotor assembly from being magnetically attracted by the stator assembly, and further shall have the support bracket to be drilled purposely so as to remove the air gap spacer off the permanent magnet motor; accordingly, it is an object of the present invention to provide a horizontal assembly method for permanent magnet motor that can finish the assembling of the rotor assembly and the stator assembly without the involvement of the air gas spacer by rearranging the assembly order and altering the arrangement on the motor assembly platform.

In this disclosure, a horizontal assembly method for permanent magnet motor includes Step (A) to Step (H) as follows.

Firstly, Step (A) is to prepare a motor assembly platform, the motor assembly platform including a platform body, a fixed support end, a movable support end and a sliding carrier, the fixed support end and the movable support end being disposed at opposite ends of the platform body, the fixed support end having a fixed thimble extending toward the movable support end, the movable support end having a movable thimble extending toward the fixed support end, the sliding carrier being movably disposed on the platform body between the fixed support end and the movable support end to move along a sliding path.

Step (B) is to sleeve movably a first bracket and a second bracket to the fixed thimble and the movable thimble, respectively.

Step (C) is to fix a stator assembly on the sliding carrier, then moving the sliding carrier along the sliding path toward the fixed support end to sleeve the stator assembly to the fixed thimble by being close to the first bracket.

Step (D) is to fix the first bracket to one end of the stator assembly.

Step (E) is to dispose a rotor assembly between the fixed thimble and the movable thimble to have two opposite ends of a rotational shaft of the rotor assembly to target the movable thimble and the fixed thimble, respectively.

Step (F) is to control the movable thimble to protrude toward the fixed thimble to have the two opposite ends of the rotational shaft to be fixedly contacted by the movable thimble and the fixed thimble, respectively.

Step (G) is to control the sliding carrier to move toward the movable support end along the sliding path to sleeve the stator assembly to the rotor assembly.

Step (H) is to fix the second bracket to another end of the stator assembly opposite to the first bracket to form a permanent magnet motor.

In one embodiment of this disclosure, the horizontal assembly method for permanent magnet motor further includes a step (I) after the step (H) to control the movable thimble to leave off the rotational shaft for releasing the rotational shaft.

In one embodiment of this disclosure, in the step (E), two hanging belts are used to hang two opposite ends of the rotational shaft, respectively, so as to dispose the rotor assembly between the fixed thimble and the movable thimble.

In one embodiment of this disclosure, the movable thimble is a manual telescopic movable thimble, and, in the step (F), the movable thimble is manually operated to protrude toward the fixed thimble.

As stated, the horizontal assembly method for permanent magnet motor provided in this disclosure is mainly to firstly dispose the first bracket and the second bracket on the motor assembly platform, then fix the stator assembly on the sliding carrier so as to move with the sliding carrier to sleeve over the fixed thimble to engage the first bracket, then position the rotor assembly between the fixed thimble and the movable thimble so as to fix the rotor assembly by the protruding movable thimble, then control the sliding carrier to assemble the stator assembly and the first bracket to the rotor assembly so that the one end of the rotational shaft can be supported by the first bracket, and finally assemble the second bracket to the stator assembly so as to support another end of the rotational shaft. Thereupon, the permanent magnet motor can be produced.

All these objects are achieved by the horizontal assembly method for permanent magnet motor described below.

### BRIEF DESCRIPTION OF THE DRAWINGS

The present invention will now be specified with reference to its preferred embodiment illustrated in the drawings, in which:

FIG. 1 is a schematic view of a motor assembly platform prepared for the horizontal assembly method for permanent magnet motor in accordance with this disclosure;

FIG. 2 is a schematic view showing that the first bracket and the second bracket are disposed to the fixed thimble and the movable thimble, respectively, in the horizontal assembly method for permanent magnet motor provided by this disclosure;

FIG. 3 is a schematic view showing that the stator assembly is fixed to the sliding carrier in the horizontal assembly method for permanent magnet motor provided by this disclosure;

FIG. 4 is a schematic view showing that the sliding carrier moves toward the fixed support end to drive the stator assembly to penetrate through the fixed thimble in the horizontal assembly method for permanent magnet motor provided by this disclosure;

FIG. 5 is a schematic view showing that the hanging belt is used to hang the rotor assembly in the horizontal assembly method for permanent magnet motor provided by this disclosure;

FIG. 6 is a schematic view showing that the rotor assembly is hanged between the fixed thimble and the movable thimble in the horizontal assembly method for permanent magnet motor provided by this disclosure;

FIG. 7 is a schematic view showing that the movable thimble is protruded out to have the rotational shaft to be fixed between the movable thimble and the fixed thimble in the horizontal assembly method for permanent magnet motor provided by this disclosure;

FIG. 8 is a schematic view showing that the hanging belt is removed to suspend the rotor assembly between the fixed thimble and the movable thimble in the horizontal assembly method for permanent magnet motor provided by this disclosure;

FIG. 9 is a schematic view showing that the sliding carrier carries the stator assembly to move toward the movable support end to sleeve the rotor assembly into the stator assembly in the horizontal assembly method for permanent magnet motor provided by this disclosure; and

FIG. 10 is a schematic view showing that the second bracket is assembled to the stator assembly so as to form the permanent magnet motor in the horizontal assembly method for permanent magnet motor provided by this disclosure.

### DESCRIPTION OF THE PREFERRED EMBODIMENT

The invention disclosed herein is directed to a horizontal assembly method for permanent magnet motor. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In this disclosure, a preferred embodiment of a horizontal assembly method for permanent magnet motor includes at least Step (A) to Step (I) as follows.

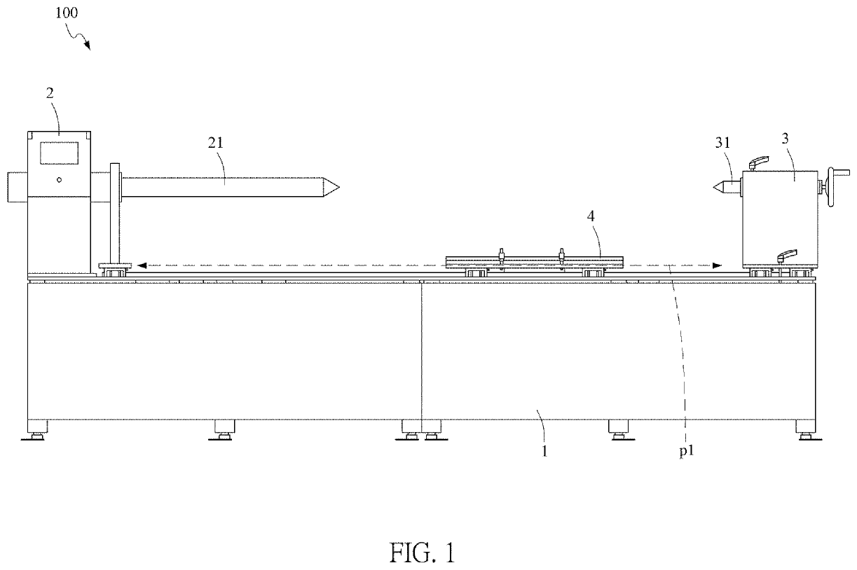

Referring to FIG. 1, a schematic view of a motor assembly platform prepared for the horizontal assembly method for permanent magnet motor in accordance with this disclosure is shown. As illustrated, Step (A) of this embodiment is to prepare a motor assembly platform 100, and the motor assembly platform 100 includes a platform body 1, a fixed support end 2, a movable support end 3 and a sliding carrier 4.

The fixed support end 2 and the movable support end 3 are disposed to opposite ends of the platform body 1. The fixed support end 2 has a fixed thimble 21 extending toward the movable support end 3, the movable support end 3 has a movable thimble 31 extending toward the fixed support end 2, and the movable thimble 31 is controllable to approach or leave the fixed support end 2. In this disclosure, the movable thimble 31 can be electrically or manually controlled. In particular, the movable thimble 31 of this embodiment is a manual telescopic movable thimble, which can be operated manually through a rotational disk. The sliding carrier 4, disposed between the fixed support end 2 and the movable support end 3, can slide along a sliding path p1 on the platform body 1.

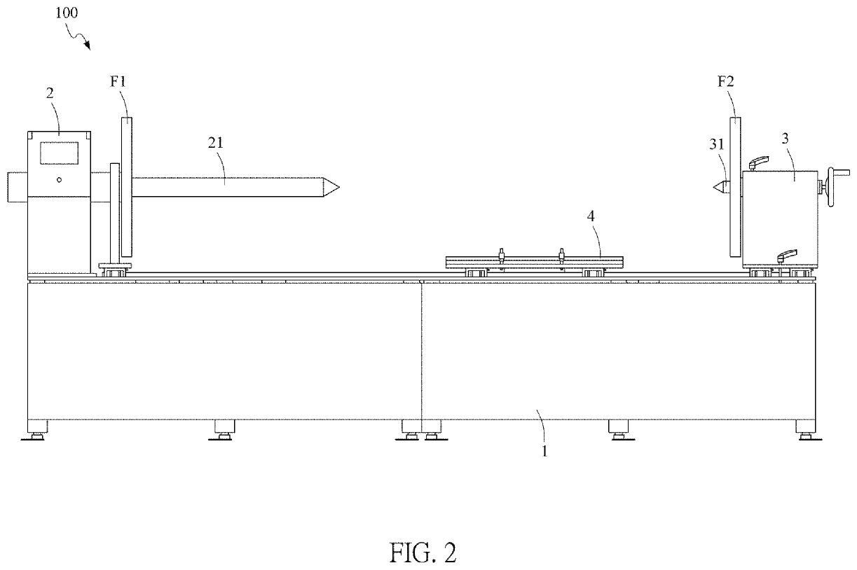

FIG. 2 is a schematic view showing that the first bracket and the second bracket are disposed to the fixed thimble and the movable thimble, respectively, in the horizontal assembly method for permanent magnet motor provided by this disclosure. As shown in FIG. 1 and FIG. 2, Step (B) is to sleeve movably a first bracket Fl and a second bracket F2 to the fixed thimble 21 and the movable thimble 31, respectively.

As described above, in this embodiment, the first bracket F1 is disposed at the fixed thimble 21 by sleeving, and the second bracket F2 is disposed at the movable thimble 31 by sleeving. In addition, practically, the first bracket F1 and the second bracket F2 are manually mounted to the fixed thimble 21 and the movable thimble 31, respectively.

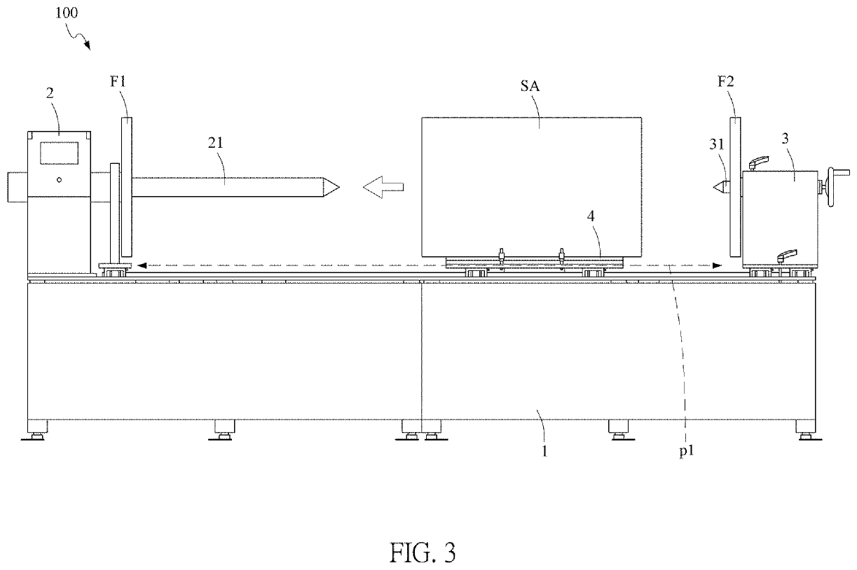

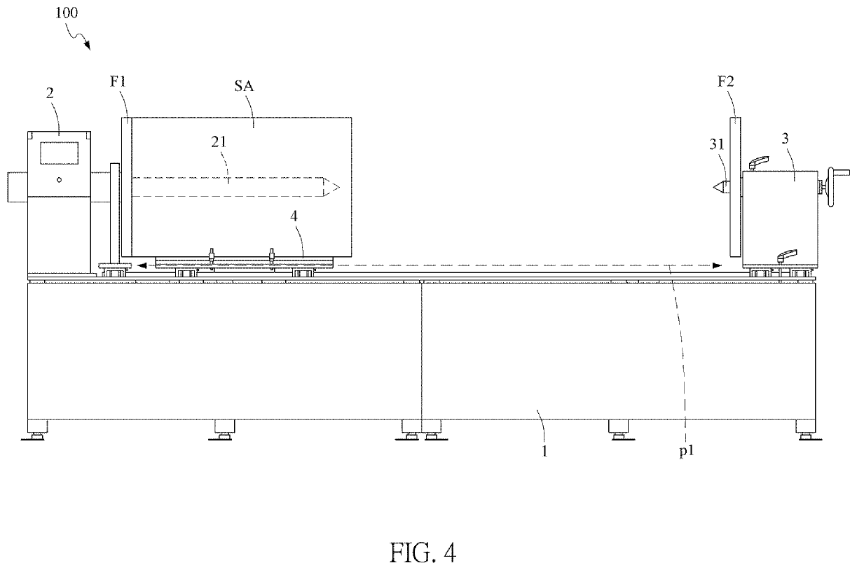

Refer to FIG. 3 and FIG. 4; where FIG. 3 is a schematic view showing that the stator assembly is fixed to the sliding carrier in the horizontal assembly method for permanent magnet motor provided by this disclosure, and FIG. 4 is a schematic view showing that the sliding carrier moves toward the fixed support end to drive the stator assembly to penetrate through the fixed thimble in the horizontal assembly method for permanent magnet motor provided by this disclosure.

As shown from FIG. 2 to FIG. 4, Step (C) is to fix a stator assembly SA onto the sliding carrier 4, and the sliding carrier 4 is controlled to move toward the fixed support end 2 along the sliding path p1 so as to sleeve the stator assembly SA over the fixed thimble 21 by being close to the first bracket F1. In this embodiment, the sliding carrier 4 can be driven by the motor mounted at the platform body 1, but not limited thereto. In some other embodiments, the stator assembly SA can be manually driven.

Practically, an overhead crane or the like crane is used to hang and then fix the stator assembly SA onto the sliding carrier 4, but not limited thereto. Alternatively, a stacker can be used to place the stator assembly SA onto the sliding carrier 4 for further locking.

Step (D) is to fix the first bracket F1 to one end of the stator assembly SA. Practically, the first bracket F1 can be locked to the stator assembly SA by screwing.

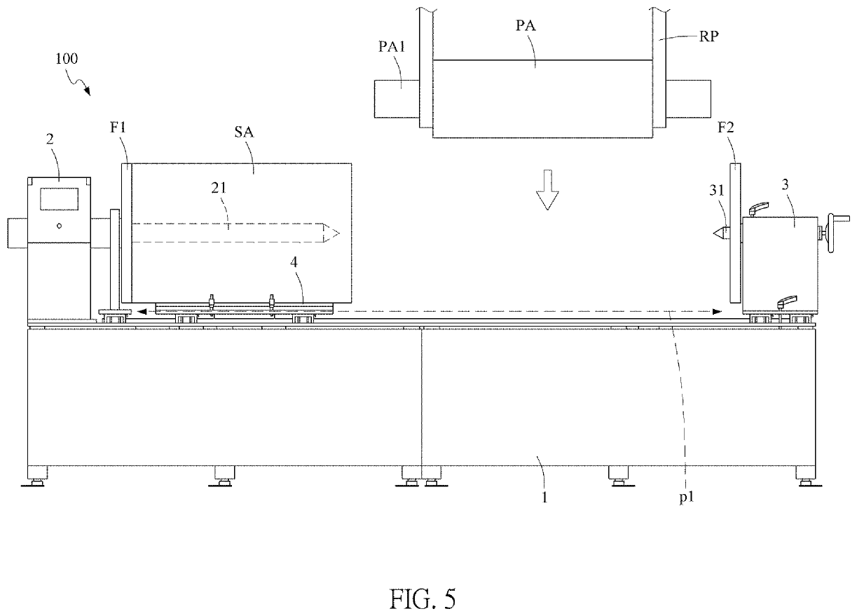

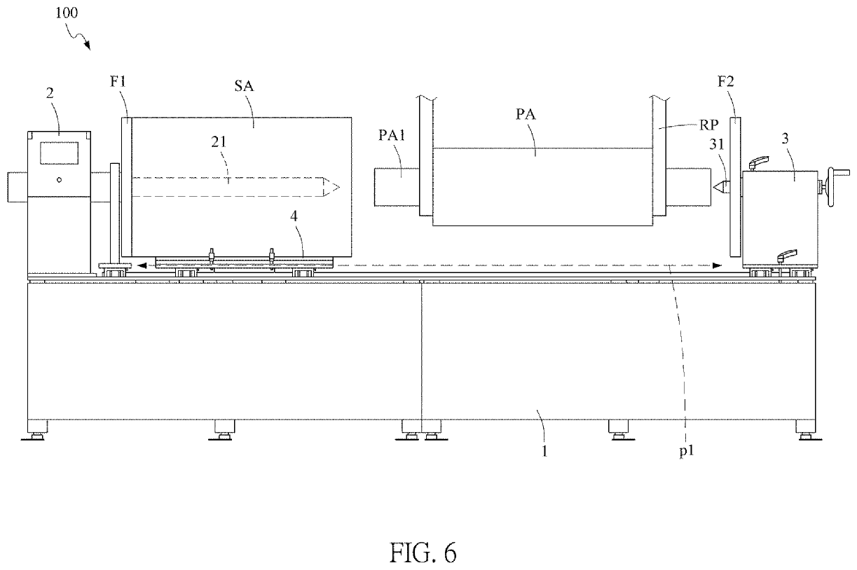

Refer to FIG. 5 and FIG. 6; where FIG. 5 is a schematic view showing that the hanging belt is used to hang the rotor assembly in the horizontal assembly method for permanent magnet motor provided by this disclosure, and FIG. 6 is a schematic view showing that the rotor assembly is hanged between the fixed thimble and the movable thimble in the horizontal assembly method for permanent magnet motor provided by this disclosure.

Referring to FIG. 4 through FIG. 6, Step (E) is to dispose a rotor assembly PA between the fixed thimble 21 and the movable thimble 31, by having opposite ends of a rotational shaft PAI of the rotor assembly PA to target the movable thimble 31 and the fixed thimble 21, respectively. In this embodiment, while in hanging the rotor assembly PA, two hanging belts RP (one labeled in the figure) can be applied to opposite ends of the rotational shaft PAI of the rotor assembly PA. Then, the rotor assembly PA can be moved to dispose between the fixed support end 2 and the movable support end 3 so as to have the rotational shaft PA1 to to be properly positioned between the fixed thimble 21 and the movable thimble 31. In this exemplary example, the two hanging belts RP are connected to the overhead crane or the like crane.

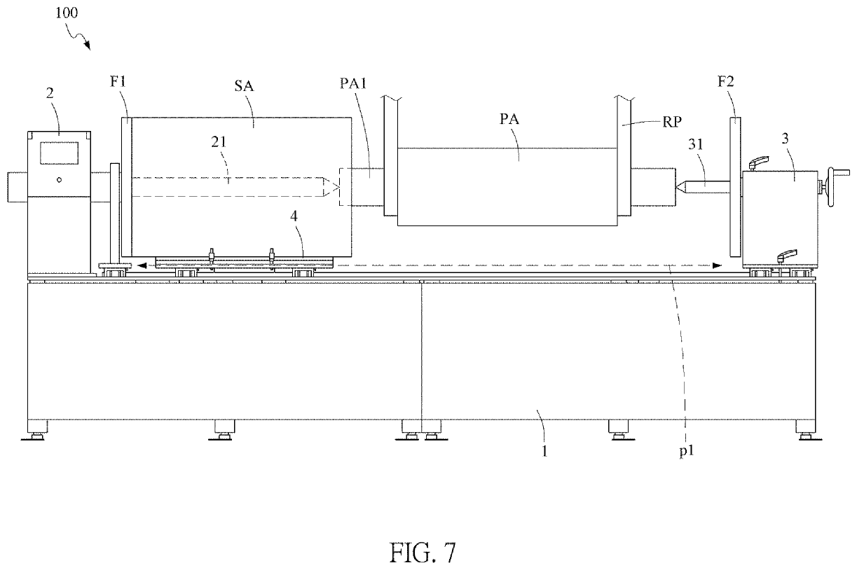

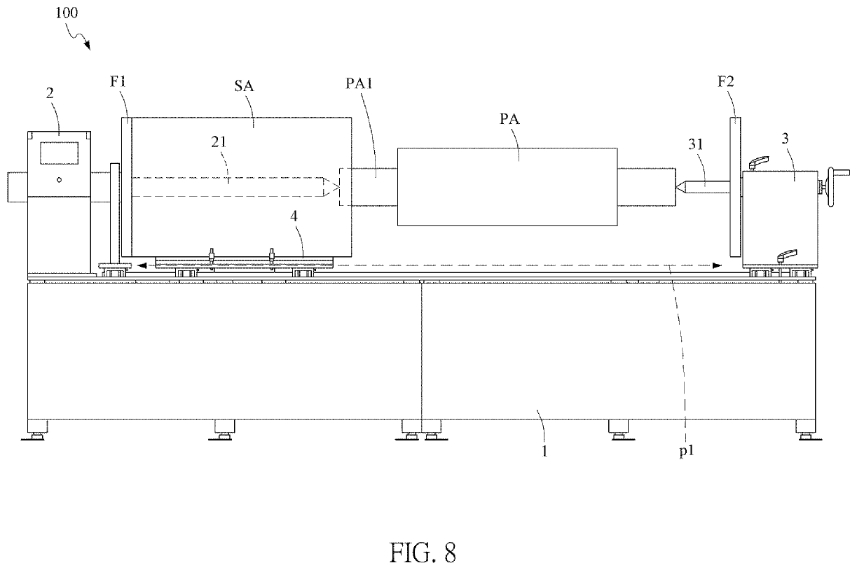

Refer to FIG. 7 and FIG. 8; where FIG. 7 is a schematic view showing that the movable thimble is protruded out to have the rotational shaft to be fixed between the movable thimble and the fixed thimble in the horizontal assembly method for permanent magnet motor provided by this disclosure, and FIG. 8 is a schematic view showing that the hanging belt is removed to suspend the rotor assembly between the fixed thimble and the movable thimble in the horizontal assembly method for permanent magnet motor provided by this disclosure.

As shown in FIG. 6 to FIG. 8, Step (F) is to control the movable thimble 31 to protrude out toward the fixed thimble 21, such that the two opposite ends of the rotational shaft PAI can be fixedly contacted by the movable thimble 31 and the fixed thimble 21, respectively. After the rotational shaft PA1 is positioned between the movable thimble 31 and the fixed thimble 21, the hanging belts RP hanging the rotor assembly PA can be then released off, and thus the rotor assembly PA can be suspended between the fixed support end 2 and the movable support end 3. In addition, in this embodiment, since the movable thimble 31 is a manual telescopic movable thimble, thus the movable thimble 31 can be manually operated to protrude toward the fixed thimble 21, but not limited thereto. In some other embodiments, the movable thimble 31 can be electrically controlled to undergo the protruding.

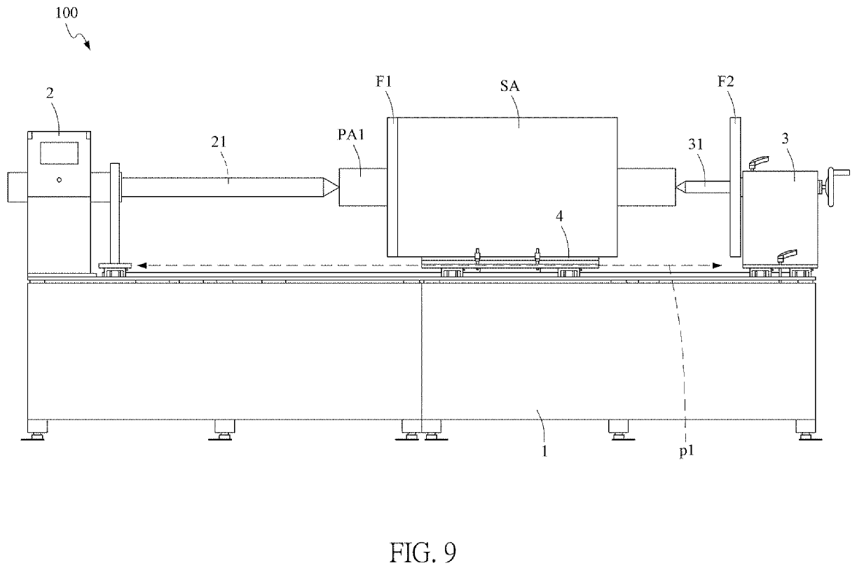

Referring to FIG. 9, a schematic view showing that the sliding carrier carries the stator assembly to move toward the movable support end to sleeve the rotor assembly into the stator assembly in the horizontal assembly method for permanent magnet motor provided by this disclosure is shown.

As shown in FIG. 8 and FIG. 9, Step (G) is to control the sliding carrier 4 to move toward the movable support end 3 along the sliding path pl, such that the rotor assembly PA can be sleeved by the stator assembly SA. Practically, when the stator assembly SA and the rotor assembly PA are telescoped coaxially, the first bracket Fl would sleeve and support the rotational shaft PA 1.

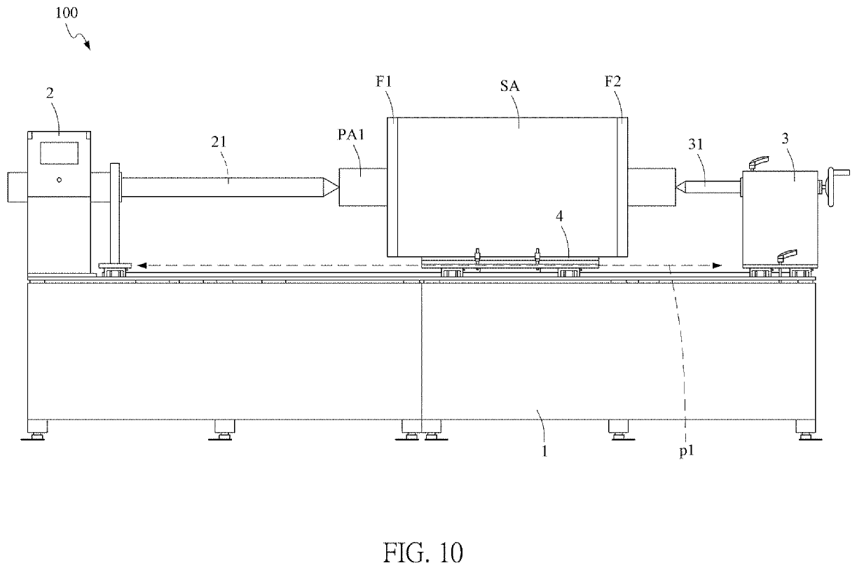

Referring to FIG. 10, a schematic view showing that the second bracket is assembled to the stator assembly so as to form the permanent magnet motor in the horizontal assembly method for permanent magnet motor provided by this disclosure is shown.

As shown in FIG. 9 and FIG. 10, Step (H) is to fix the second bracket F2 to another end of the stator assembly SA opposite to the first bracket F 1, so as to produce a permanent magnet motor (not labeled in the figure) having the stator assembly SA, the rotor assembly PA, the first bracket Fl and the second bracket F2.

In addition, after the permanent magnet motor has been assembled, Step (I) is further provided to control the movable thimble 31 to move off the rotational shaft PA1, such that the rotational shaft PA1 can be released.

In summary, the horizontal assembly method for permanent magnet motor provided in this disclosure is mainly to firstly dispose the first bracket and the second bracket on the motor assembly platform, then fix the stator assembly on the sliding carrier so as to move with the sliding carrier to sleeve over the fixed thimble to engage the first bracket, then position the rotor assembly between the fixed thimble and the movable thimble so as to fix the rotor assembly by the protruding movable thimble, then control the sliding carrier to assemble the stator assembly and the first bracket to the rotor assembly so that the one end of the rotational shaft can be supported by the first bracket, and finally assemble the second bracket to the stator assembly so as to support another end of the rotational shaft. Thereupon, the permanent magnet motor can be produced. In this disclosure, since the fixed thimble and the movable thimble are utilized together to fix the rotor assembly, thus, when the stator assembly is moved to sleeve the rotor assembly, no problem caused by magnetic attraction to affect the assembling of the stator assembly and the rotor assembly needs to be concerned. Namely, no more air gap spacer in the art is required, and also the support bracket needn't to be drilled any more, such that the assembling convenience can be increased, the assembling efficiency can be promoted, and the production cost can be reduced.

While the present invention has been particularly shown and described with reference to a preferred embodiment, it will be understood by those skilled in the art that various changes in form and detail may be without departing from the spirit and scope of the present invention.

What is claimed is:

1. A horizontal assembly method for permanent magnet motor, comprising the steps of:
(A) preparing a motor assembly platform, the motor assembly platform including a platform body, a fixed support end, a movable support end and a sliding carrier, the fixed support end and the movable support end being disposed at opposite ends of the platform body, the fixed support end having a fixed thimble extending toward the movable support end, the movable support end having a movable thimble extending toward the fixed support end, the sliding carrier being movably disposed on the platform body between the fixed support end and the movable support end to move along a sliding path;
(B) sleeving movably a first bracket and a second bracket to the fixed thimble and the movable thimble, respectively;
(C) fixing a stator assembly on the sliding carrier, then moving the sliding carrier along the sliding path toward the fixed support end to sleeve the stator assembly to the fixed thimble by being close to the first bracket;
(D) fixing the first bracket to one end of the stator assembly;
(E) disposing a rotor assembly between the fixed thimble and the movable thimble to have two opposite ends of a rotational shaft of the rotor assembly to target the movable thimble and the fixed thimble, respectively;
(F) controlling the movable thimble to protrude toward the fixed thimble to have the two opposite ends of the rotational shaft to be fixedly contacted by the movable thimble and the fixed thimble, respectively;
(G) controlling the sliding carrier to move toward the movable support end along the sliding path to sleeve the stator assembly to the rotor assembly; and
(H) fixing the second bracket to another end of the stator assembly opposite to the first bracket to form a permanent magnet motor.

2. The horizontal assembly method for permanent magnet motor of claim 1, further including a step (I) after the step (H) to control the movable thimble to leave off the rotational shaft for releasing the rotational shaft.

3. The horizontal assembly method for permanent magnet motor of claim 1, wherein, in the step (E), two hanging belts are used to hang two opposite ends of the rotational shaft, respectively, so as to dispose the rotor assembly between the fixed thimble and the movable thimble.

4. The horizontal assembly method for permanent magnet motor of claim 1, wherein the movable thimble is a manual telescopic movable thimble, and, in the step (F), the movable thimble is manually operated to protrude toward the fixed thimble.
